(19) United States
(12) Patent Application Publication
(10) Pub. No.: US 2009/0230898 A1
(43) Pub. Date: Sep. 17, 2009

(54) SERVO AMPLIFIER WITH REGENERATIVE FUNCTION

(75) Inventors: Shunsuke Matsubara, Minamitsuru-gun (JP); Yasusuke Iwashita, Minamitsuru-gun (JP); Shinichi Horikoshi, Minamitsuru-gun (JP); Naoyuki Suzuki, Minamitsuru-gun (JP)

Correspondence Address: DRINKER BIDDLE & REATH (DC), 1500 K STREET, N.W., SUITE 1100, WASHINGTON, DC, 20005-1209, US

(73) Assignee: FANUC LTD, Minamitsuru-gun (JP)

(21) Appl. No.: 12/356,928

(22) Filed: Jan. 21, 2009

(30) Foreign Application Priority Data
Mar. 13, 2008 (JP) 2008-064169

(51) Int. Cl. H02P 3/14

(52) U.S. Cl. 318/376

(57) ABSTRACT

A servo amplifier for a robot capable of avoiding an excessive capacity for dealing with a regenerative power to achieve downsizing, cost reduction and energy saving of the device. A servo amplifier for driving servomotors of a robot to perform an operation using an electric power from a power source. The servo amplifier comprises a changeable converter connected with the power source and a plurality of inverters electrically connected with the converter and the servomotors. The changeable converter is selectively provided as a converter having a regenerative function of returning a regenerative power generated in the servomotors to the power source, or a converter having a regenerative function of discharging the regenerative power through a resistor, depending on conditions of the operation by the robot.

### BACKGROUND OF THE INVENTION

1. Field of the Invention

The present invention relates to a servo amplifier for driving servomotors, and in particular to a servo amplifier selectively provided with a function of returning a regenerative power generated in the servomotors to a power source.

2. Description of Related Art

In a drive controller for drivingly controlling motors of respective axes of a robot, a machine tool and a manufacturing machine, etc., there has been used a servo amplifier which converts a commercial alternating current into a direct current and then inverts the direct current into an alternating current of an appropriate frequency to drive the motors so that velocities of the respective axes are controlled.

FIG. 6 schematically shows a servo amplifier for driving motors for control axes of a robot as disclosed in JP 2004-23956A. A motor driving device 10 serving as the servo amplifier comprises an alternating-current/direct-current (AC/DC) converting section (converter) 11 and a plurality of direct-current/alternating-current (DC/AC) inverting sections (inverters) 12-1, . . . 12-n of the number “n” corresponding to the number of control axes (motors) of a robot 30 to be controlled. The inverters 12-1 through 12-n are connected to the motors of the respective axes of the robot 30. The converter is a device for converting an electric power of alternating current supplied from a power source to an electric power of direct current, and the inverter is a device for inverting the electric power of direct current into an electric power of alternating current.

Further, there are provided servomotors 31a, 31b for respectively driving a servo gun of a spot welder attached to a wrist of a robot arm, and a positioner for conveying and positioning an object of operation of the robot 30, as peripheral devices of the robot 30. The inverters 20a, 20b for the servomotors 31a, 31b are electrically connected to the converter 11 through an interface 14 and the converter 11 provides a direct current to the inverters 20a, 20b.

The inverters 20a and 20b are connected to a servo controller (not shown) through an interface 13 provided in the servo amplifier 10 and send/receive control signals S1 and status signals S2 to/from the servo controller.

In the above-described servo amplifier, specifications of the inverters can be determined in accordance with specifications of the motors to be driven. However, it is not appropriate to fixedly set specifications of the converter concerning a type and a capacity of regenerative function since frequency of acceleration/deceleration of the servomotors and magnitude of loads exerted on the servomotors are greatly different in dependence on conditions of use of the robot.

In a converter having a regenerative function of returning a regenerative power generated in the servomotors to a power source (hereinafter referred to as a regenerative function of power-source returning type), it is required to have an arrangement to prevent transistors in the converter from breakage by the regenerative power and an arrangement to prevent an undesirable effect on the power source by the regenerative power.

In a converter having a regenerative function of discharging the regenerative power through a resistor (hereinafter referred to as a regenerative function of resistor discharging type), as shown in FIG. 7, it is possible to cope with variation of the DC link voltage by the regeneration power by using a regeneration resistor (REG) having a sufficiently large capacity. However, a regeneration resistor with a large capacity has a large volume for bearing large heat generation. Thus, it is desirable to use a capacitor having a capacitance as small as possible in view of an installation space of the regeneration resistor and a cost of manufacturing thereof.

Also, in the converter with the regenerative function of power-source returning type, a capacitor having a large capacitance, such as a double layer capacitor, for storing the regenerative power has a large volume. In view of the installing space of the capacitor and the cost of manufacturing thereof, it is desirable to use a regeneration capacitor having a capacity as small as possible.

In the servo amplifier 10 for driving the servomotors of the robot 30 as shown in FIG. 6, the load of the converter for dealing with the regenerative power increases as frequency of acceleration/deceleration of the servomotors increases and the number of inverters (additional axes) connected to the converter increases. To cope with the situation, the servo amplifier has to be provided with excessive capability having high cost and large size, to make it difficult to provide servo amplifiers sufficiently meeting needs of users.

### SUMMARY OF THE INVENTION

The present invention provides a servo amplifier provided with an optimal type of regenerative function and an optimal regenerative capacity in dependence on conditions of use of the servo amplifier.

A servo amplifier of the present invention drives servomotors of a robot to perform an operation using an electric power from a power source. The servo amplifier comprises: a changeable converter connected with the power source and selectively provided as a converter having a function of returning a regenerative power generated in the servomotors to the power source, or a converter having a function of discharging the regenerative power through a resistor, depending on conditions of the operation by the robot; and a plurality of inverters electrically connected with said converter and the servomotors.

The converter may have a function of rapidly discharging a voltage of a DC link connecting the converter and the inverters in an emergency stop or in shutting down the power source.

The converter may have a function of determining start and end of the regenerative function based on information about power running or regenerative running of the servomotors received from the plurality of inverters.

The converter may start the regenerative function when a voltage of a DC link connecting the converter and the inverters reaches a predetermined value, and perform switching of the regenerative power in synchronism with phases of the power source.

The converter may perform switching of the regenerative power so that a voltage of a DC link connecting the converter and the inverters is retained at a predetermined value.

### BRIEF DESCRIPTION OF THE DRAWINGS

FIGS. 1a and 1b are schematic block diagrams of servo amplifiers each comprising a converter with the regenerative function of power-source returning type and a plurality of inverters connected with the converter, according to the present invention;

FIG. 2 is a schematic view of an embodiment in which a converter and inverters are arranged as a unit according to the present invention;

FIG. 3 is a schematic view of an embodiment in which a converter and inverters are arranged separately according to the present invention;

FIGS. 4a and 4b are block diagrams of servo amplifiers each comprising a converter which is selectively provided as a converter having the regenerative function of power-source returning type or a converter having the regenerative function of resistor discharging type, and a plurality of inverters connected with the converter, according to the present invention;

FIG. 5 is a graph showing a function of rapidly discharging a DC link voltage according to the present invention;

FIG. 6 is a block diagram of a conventional servo amplifier; and

FIG. 7 is a block diagram of a motor driving device in which a converter having the regenerative function of resistor discharging type and a plurality of inverters are connected, according to the prior art.

### DETAILED DESCRIPTION

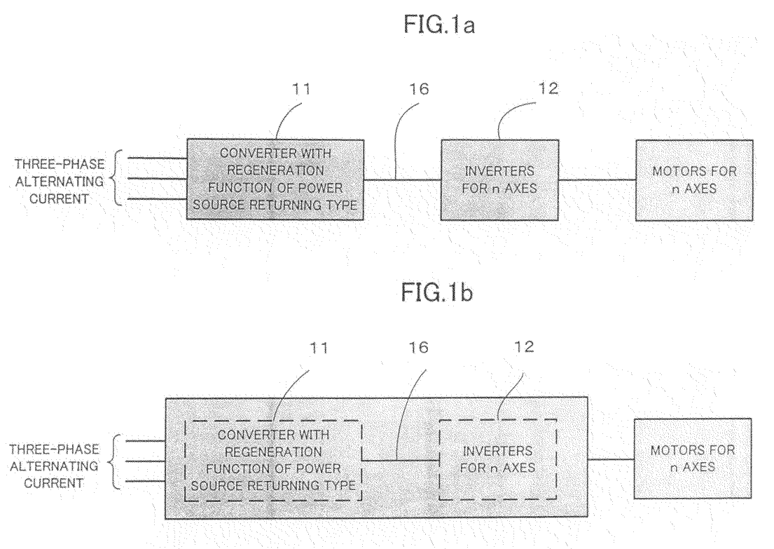

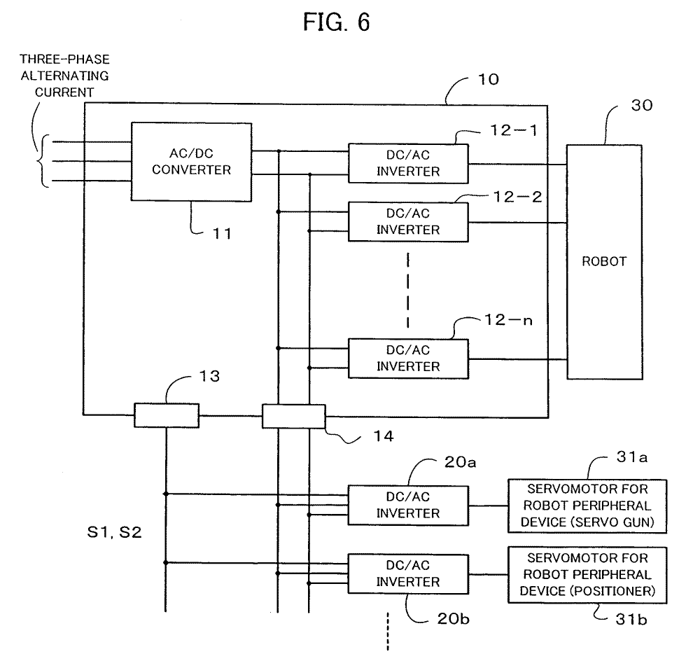

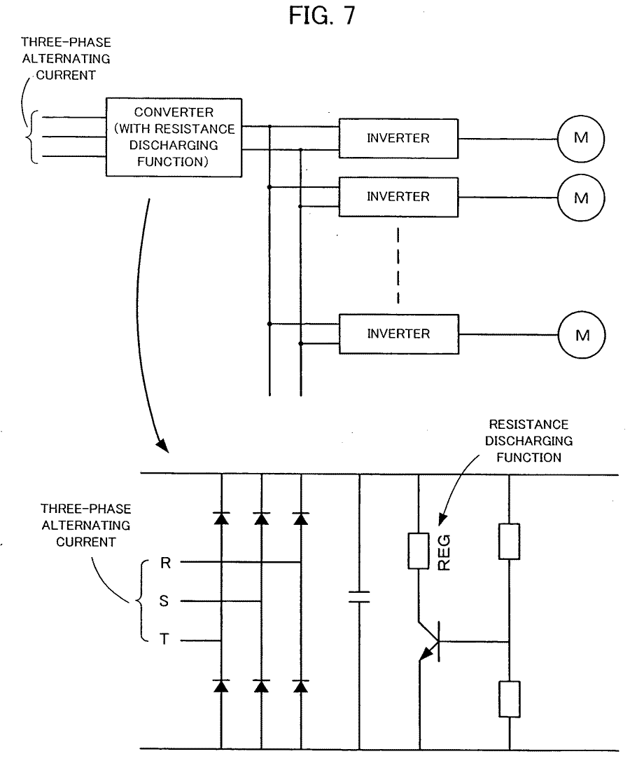

Embodiments of the present invention will be described referring to FIGS. 1 to 5. In these figures, an element having the same or equivalent function as an element in the prior art shown in FIGS. 6 and 7 is denoted by the same numeral.

FIG. 1b schematically shows an integral-type servo amplifier in which a converter having the regenerative function of power-source returning type and a plurality of inverters electrically connected to the converter are arranged to form a unit. FIG. 1a shows a separate-type servo amplifier in which a converter having the regenerative function of power-source returning type and a plurality of inverters electrically connected to the converter are arranged separately.

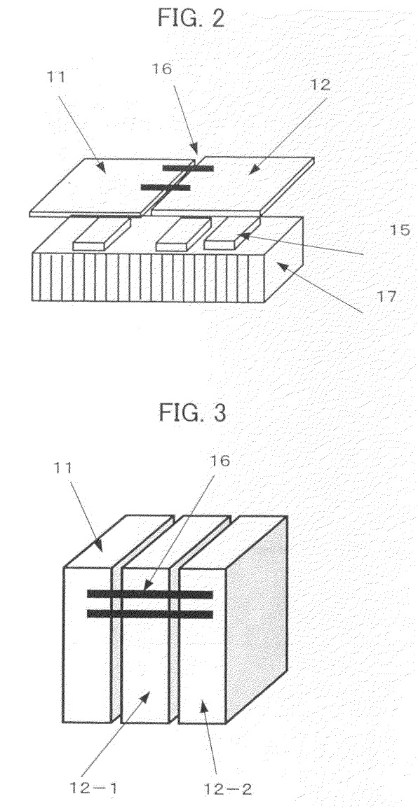

An embodiment of a servo amplifier of the integral-type is shown in FIG. 2. A converter 11 having the regenerative function of power-source returning type and an inverter 12 are fixed on a single heat sink 17. The converter 11 and the inverter 12 are electrically connected with each other by a DC link 16. The DC link 16 is formed by a short bar or a fastened screw, for example. Power semiconductors 15 are arranged on the heat sink 17. The unit of the converter 11 and the inverter 12 is arranged on the heat sink 17 with the power semiconductors 15 therebetween.

An embodiment of a servo amplifier of the separate type is shown in FIG. 3. A converter 11 with the regenerative function of power-source returning type and two inverters 12-1 and 12-2 are accommodated in respective casings and the converter 11 and the two inverters 12-1 and 12-2 respectively accommodated in the casings are electrically connected with each other by a DC link 16. The converter 11 and the two inverters 12-1 and 12-2 are independently provided and arranged on respective heat sinks.

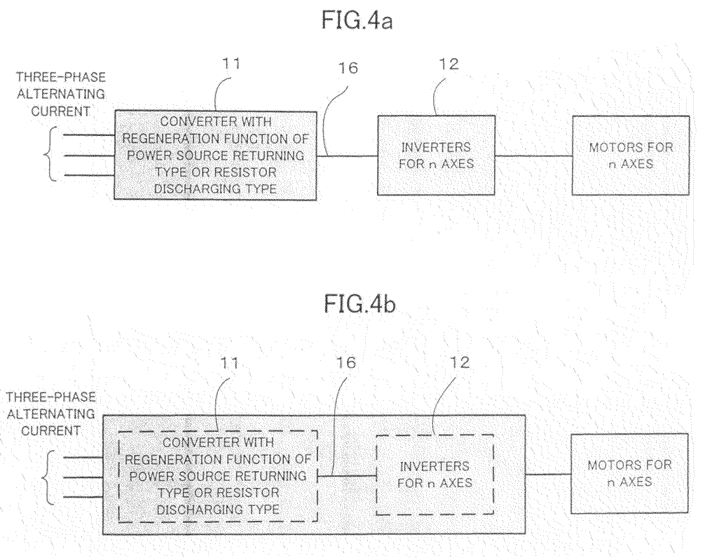

FIGS. 4a and 4b schematically show a servo amplifier in which a converter is selectively provided as a converter having the regenerative function of power-source returning type, or a converter having the regenerative function of resistor discharging type in dependence on conditions of operations to be performed by the robot in the arrangements as shown in FIGS. 1a and 1b.

In the case where there is not any electric apparatus consuming the regenerative power returned to the power source in the vicinity of the power source, or in the case where the regenerative power exceeds an capacity of the power source, it is preferable not to use the converter having the regenerative function of power-source returning type, but to use the converter having the regenerative function of resister discharging type.

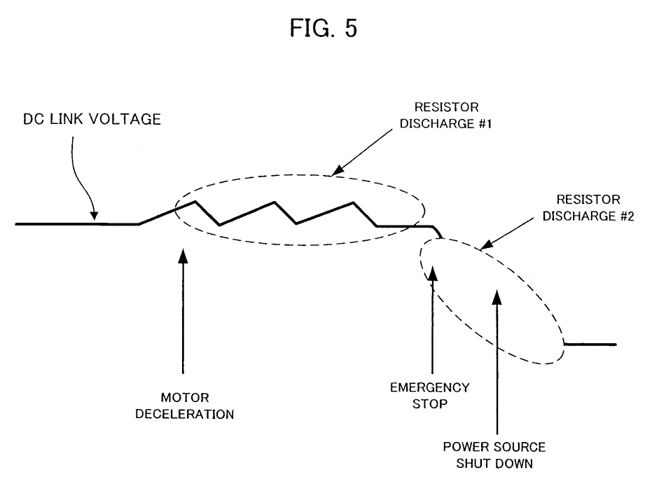

As described, the present invention provides a servo amplifier for controlling servomotors of a robot selectively provided with an appropriate type of regenerative function and an appropriate capacity of coping with the regenerative power. However, there is a possibility that an allowable capacity of the power source is exceeded by a regenerative power produced above assumption by an unforeseen cause. Therefore, there is provided an arrangement to rapidly discharge the voltage of the DC link 16 when the excessive regenerative power is generated. FIG. 5 shows a variation of the DC link voltage when the DC link voltage is rapidly discharged. A resistor discharge #1 is performed by consuming the regenerative power generated in deceleration of the motor in a usual operation of the motor by the resistor. An excessive regenerative power generated in an emergency stop of the motor or a shut down of the power source is consumed by a resistor discharge #2 to rapidly reduce the DC link voltage.

In the case of the converter 11 with the regenerative function of power-source returning type, the converter 11 starts returning the regenerative power to the power source when the DC link voltage reaches a predetermined value, and performs switching of the regenerative power in synchronism with the phase of the power source. Thereby, switching devices are prevented from unnecessary wears in a case where the switching of the DC link voltage is always performed irrespective of the deceleration of the servomotors.

In this case, the converter 11 may determines start and end of the regenerative function based on information about power running or regenerative running of the servomotors received from the inverters 12.

A PWM converter can be adopted as the converter 11. The switching may be performed in the power running and also in performing the regenerative function to control the DC link voltage to be constant.

The hardware of the converter 11, the inverters 12 and the controller for controlling the converter 11 and the inverters 12 may be constructed by conventional devices.

As described, according to the present invention, there is provided a servo amplifier suitable for a robot and selectively provided with an optimal type of regenerative function and an optimal capacity of dealing with the regenerative power generated in servomotors depending on conditions of operations by the robot, to avoid excessive high specification of a converter to thereby achieve downsizing, cost reduction and energy saving of the device.

What is claimed is:

1. A servo amplifier for driving servomotors of a robot to perform an operation using an electric power from a power source, comprising:
a changeable converter connected with the power source and selectively provided as a converter having a regenerative function of returning a regenerative power generated in the servomotors to the power source, or a converter having a regenerative function of discharging the regenerative power through a resistor, depending on conditions of the operation by the robot; and
a plurality of inverters electrically connected with said converter and the servomotors.

2. A servo amplifier according to claim 1, wherein said converter has a function of rapidly discharging a voltage of a DC link connecting the converter and the inverters in an emergency stop or in shutting down the power source.

3. A servo amplifier according to claim 1, wherein said converter has a function of determining start and end of the regenerative function based on information about power running or regenerative running of the servomotors received from said plurality of inverters.

4. A servo amplifier according to claim 1, wherein said converter starts the regenerative function when a voltage of a DC link connecting the converter and the inverters reaches a predetermined value, and performs switching of the regenerative power in synchronism with phases of the power source.

5. A servo amplifier according to claim 1, wherein said converter performs switching of the regenerative power so that a voltage of a DC link connecting the converter and the inverters is retained at a predetermined value.
